(19) United States
(12) Patent Application Publication
(10) Pub. No.: US 2010/0134383 A1
(43) Pub. Date: Jun. 3, 2010

(54) Plasma video scoreboard

(76) Inventors: Jeffrey Paul Mele, Wallingford, CT (US); Gregory James Downing, Hamden, CT (US)

Correspondence Address: Jeffrey Paul Mele, 106 N. Branford Rd., Wallingford, CT, 06492, US

(21) Appl. No.: 12/315,031

(22) Filed: Nov. 28, 2008

(51) Int. Cl. G09G 5/12

(52) U.S. Cl. 345/1.3

(57) ABSTRACT

A Plasma Video Scoreboard is an assembly of multiple plasma video display units to create one or multiple images, larger in surface area than any single plasma video display on the market, and is assembled with the intended capability to simultaneously displays live and pre-recorded video, advertising, player information, sports statistics, time clocks, and score for sports events. A Plasma Video Scoreboard is a melding of plasma video display technology with the conventional structure of a scoreboard.

### REFERENCES CITES [REFERENCED BY]

U.S. Patent Documents

| | | |
|---|---|---|
| 7,443,099 | October 2008 | Song et al. |
| 7,443,098 | October 2008 | Jeong |
| 5,990,616 | November 1999 | Lee et al. |
| 5,734,228 | March 1998 | Kwon et al. |
| 5,640,068 | June 1997 | Ameniya |
| 7,154,222 | December 2006 | Woo et al. |
| 2004/0,046,505 | March 2004 | Kawanishi |
| 2005/0,082,958 | April 2005 | Su et al. |
| 5,251,570 | October 1993 | Creech |
| 4,751,506 | June 1988 | Brown |
| 4,045,788 | August 1977 | Castelli et al. |

### BACKGROUND OF THE INVENTION

1. Field of the Invention
a. This invention relates to the integration of plasma video display technology into the structure of a sports scoreboard assembly and, more particularly, the ability to, in an agile manner, alter the arrangement of advertising, player information, score, statistics and live or pre-recorded video.

2. Description of Related Art
a. Scoreboards are used in sports arenas, stadiums, and other related venues to provide, at a minimum, the player information, score, and related statistics for the applicable sport-most often basketball, hockey, baseball, football, and tennis.
b. Scoreboard often integrate the said sports related information of 2.(a) with both video and advertising
c. Scoreboards are commonly:
   i. Suspended in arenas as either:
      1. Center hung scoreboards most commonly having 4 faces allowing for 360 degree horizontal viewing
      2. Side mounted, single-faced scoreboards, where one or more units are installed, provide viewing to the audience from multiple perspectives.
   ii. Suspended in center field in a baseball stadium
   iii. Suspended in one or both end-zones in a football stadium
   iv. Suspended in various locations in a tennis stadium
   v. Suspended in various locations in other venues for use during sports events
d. Scoreboards are used for the display of live video and advertising during non sporting events. In this utilization, the elements that would normally display sports related information are of little to no use.
e. Scoreboards where the scoring/sport information, advertising, and/or video elements or display components are dissimilar do not allow video images to span the entire face of the scoreboard therefore do not affording the ability to increase the size of the video image when the other content such as scoring information or not necessary.
f. The common video display elements are light emitting diode or “LED” displays comprising a plurality of light emitting diodes arranged in a large array. The light emitting diodes, being multicolor light emitters, when formed into this array create video images.
g. The video resolution of LED based scoreboards is much lower than that of plasma display technology.
h. Recent advances in plasma display technology have allowed for larger displays to be created using multiple plasma display units that have no border allowing for a “seamless” image characterized as a consistent image with gaps of 3-6 mm between units. Current LED technology is limited to 4 mm pixel width.

### SUMMARY OF THE INVENTION

01 Existing technology for the manufacture and assembly of scoreboards is limited to the following element:
   a. Video Elements
      i. LED based video displays where video images are created by arrays of multicolor “Light Emitting Diode”
   b. Scoring Information Elements
      i. LED based alphanumeric displays
      ii. Incandescent Lamp alphanumeric displays
      iii. LED based video displays where alphanumeric images are created by arrays of multicolor “Light Emitting Diode”
   c. Plasma Video Scoreboards will provide the following advantages:
      i. Eliminate the need for display elements consisting of Light Emitting Diode arrays/displays
      ii. Eliminate the need for alphanumeric displays consisting of Light Emitting Diodes and Incandescent or Florescent lamps to display time clocks, player information, statistics, and score
      iii. Dramatically increased video resolution as current LED or Light Emitting Diode technology is limited to <30 pixels per square inch and lower tier plasma display technology yields >500 pixels per square inch
      iv. Significantly decreased power consumption
      v. The ability to integrate the scoring information for a sports event into the video image legibly
      vi. The agility to move scoring information in reference to the video image
      vii. The ability to eliminate the scoring information in order to create more surface area for video

### BRIEF DESCRIPTION ON THE DRAWINGS

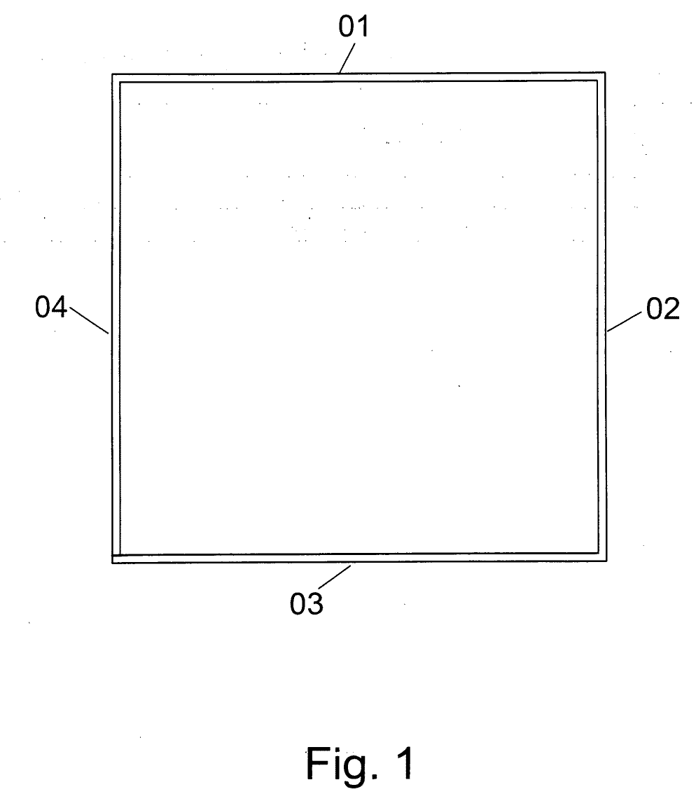

a. FIG. 1 indicates a top view of a plasma video scoreboard in physical composition

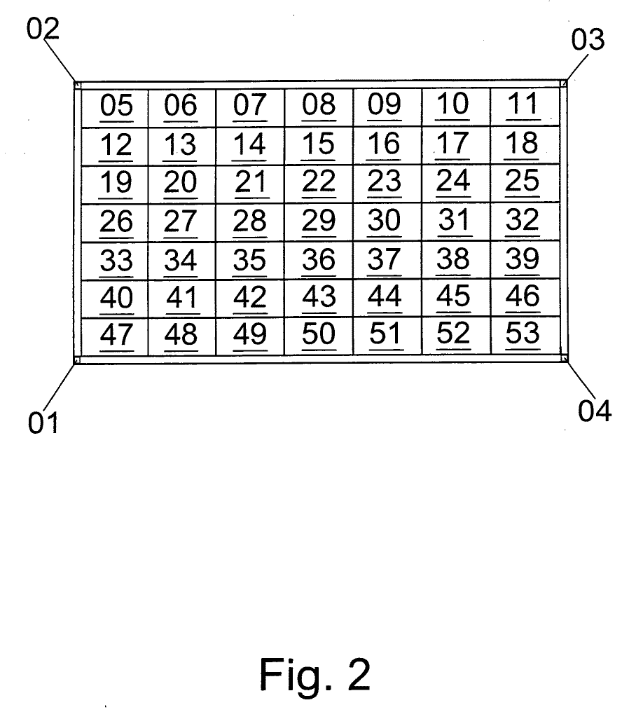

b. FIG. 2, according to claim 06, indicates a plurality of plasma video displays forming and single quasi-continuous display.

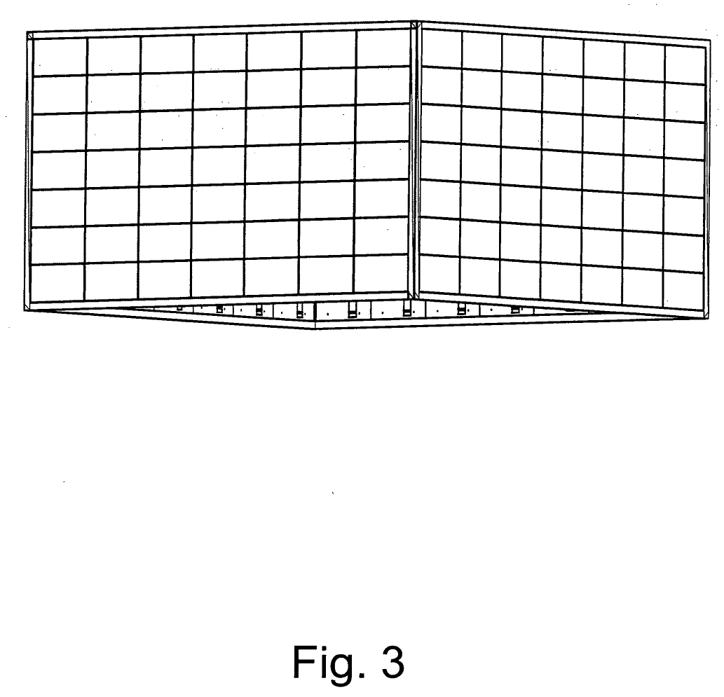

c. FIG. 3 indicates an isometric view of a plasma video scoreboard without a graphic overlay.

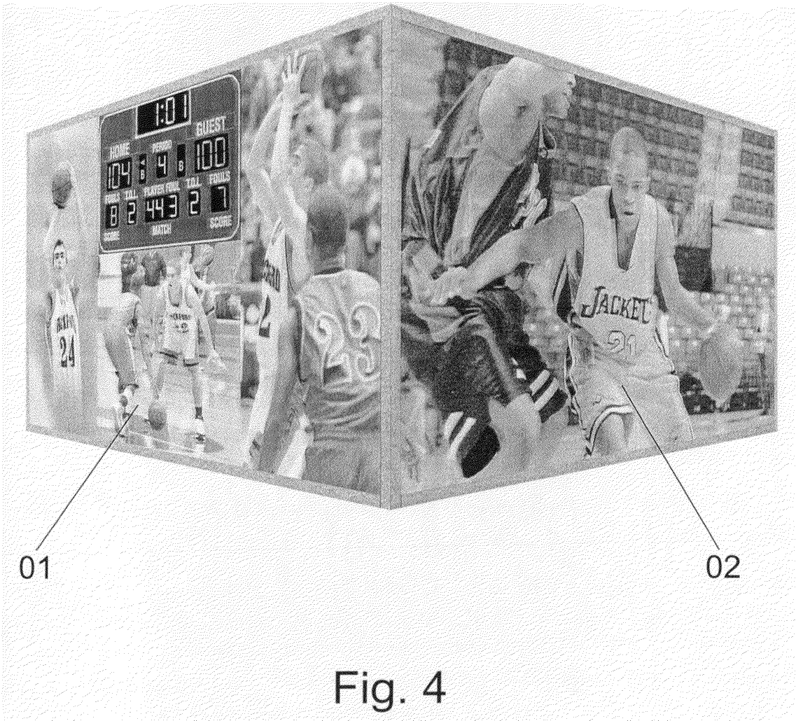

d. FIG. 4 indicates an isometric view of a plasma video scoreboard with the graphically overlay depicting its ability to simultaneously display score, time clock, player names, advertising, and video across the plasma display components without the use of non-plasma elements.

### DETAILED DESCRIPTION OF THE INVENTION

FIG. 1 indicates a plasma video scoreboard top view consisting of four faces labeled 01, 02, 03, and 04, each consisting of a plurality of plasma video display. A minimum of one face may be utilized to achieve the objects of this invention.
FIG. 2 indicates a single face of a plasma video scoreboard front view consisting of:
   A structure consisting of welded metallic members indicated by 02, 03, 04, and 05.
   A plurality of plasma video displays indicates by 05, 06, 12, and 13, formed into an array of two units tall by 2 units wide is the minimum size array.
   A plurality of plasma video displays indicated by 05 through 53, formed in an array of seven units tall by seven units wide, forms the total array. Ideally the aggregate dimension of the total array consists of a greater plurality of display units than the minimum size array. However, a greater or less number of units may be utilized to achieve the objects of this invention.
   A plurality of plasma video displays indicated by 05, 06, 07, 08, 09, 10, and 11 forms the total horizontal array.
   A plurality of plasma video displays indicated by 05, 12, 19, 26, 33, 40, and 47 forms the total vertical array.
   The total array resolution is the aggregate resolution of:
      Number of horizontal display pixels*total horizontal array size
      Number of vertical display pixels*total vertical array size
   The total array size is the aggregate dimension of the total array as:
      Total array horizontal dimension as:
         Single unit horizontal dimension*total horizontal array units
      Total array vertical dimension as:
         Single unit vertical dimension*total vertical array units
   The total array aspect ratio is the ratio of:
      Total array horizontal dimension/Total array vertical dimension
FIG. 3 indicates a plasma video scoreboard isometric view showing the arrangement of faces and displays.
FIG. 4 indicates a plasma video scoreboard isometric view with graphical overlays consisting of:
   View of 2/4 faces of a plasma video scoreboard indicated by:
      A single face indicated by 01 displaying content consisting of:
         Live Video
         Score
         Time Clock
         Game Statistics
      A single face indicated by 02 displaying content consisting of:
         Live Video
      Where the orientation, size, and aspect of each content item is bound only by the total array resolution, total array dimension, and the total array aspect ratio.

What is claimed is:

01. A plasma video scoreboard apparatus for simultaneously displaying game data, time clock, and live video content comprising:
a. a display housing.
b. a plurality of plasma video display units.

02. The plasma video scoreboard of claim 01 wherein the said apparatus is utilized in a sports arena.

03. The plasma video scoreboard of claim 01 wherein the said apparatus is utilized in a sports stadium.

04. The plasma video scoreboard of claim 01 wherein the said apparatus is utilized in a multi-purpose arena.

05. The plasma video scoreboard of claim 01 wherein the housing comprises one or multiple display faces.

06. The plasma video scoreboard of claim 05 wherein the said display face(s) comprising a plurality of plasma video display units forming a quasi-continuous display surface.

07. The plasma video scoreboard in claim 06 wherein the plurality of displays form a single video display.

08. A method for simultaneously displaying content comprising live video; video advertising; score; player information; team information; team statistics; player statistic; and game time.

09. The method of claim 08 wherein the content is arranged in an agile manner.
